(19) United States
(12) Patent Application Publication
(10) Pub. No.: US 2024/0318956 A1
(43) Pub. Date: Sep. 26, 2024

(54) Device and Method for Estimating a Current Wheel Diameter

(71) Applicant: ZF Friedrichshafen AG, Friedrichshafen (DE)

(72) Inventors: Susanne Horn, Tettnang (DE); Axel Mors, Friedrichshafen (DE); Adam Norris, Friedrichshafen (DE); Jens Giesler, Friedrichshafen (DE); David Stock, Friedrichshafen (DE); Tobias Dentler, Meckenbeuren (DE); Christian Carl, Langenargen (DE)

(21) Appl. No.: 18/613,639

(22) Filed: Mar. 22, 2024

(30) Foreign Application Priority Data
Mar. 24, 2023 (DE) 102023202709.7

(51) Int. Cl. G01B 21/12; B61K 9/12; G01M 17/10; G01P 3/54; G01P 3/64

(52) U.S. Cl. CPC G01B 21/12; B61K 9/12; G01M 17/10; G01P 3/54; G01P 3/64

(57) ABSTRACT

A device (9, 9a) for estimating a current wheel diameter of a wheel of a rail-based vehicle on a predetermined network of routes includes an interface (8) for collecting vibration data (5) of at least one wheel acting on the rail-based vehicle as an acceleration of the rail-based vehicle. The vibrations detectable using at least one wireless sensor (2a, 2b, 2c, 2d) arranged proximate the at least one wheel. A computing unit is configured for generating a predicted speed on the basis of the vibration data (5). A comparator unit is configured for estimating a wheel diameter based on differences between the predicted speed and an identified, corresponding ground truth speed (17).

### CROSS-REFERENCE TO RELATED APPLICATION

The present application is related and has right of priority to German Patent Application No. DE102023202708.9 filed on Mar. 24, 2023, which is incorporated by reference in its entirety for all purposes.

### TECHNICAL FIELD

The invention relates generally to a device for estimating a current wheel diameter of a wheel of a rail-based vehicle on a predetermined network of routes, the device having an interface for collecting vibration data as vibrations, of at least one wheel, acting on the rail-based vehicle, as an acceleration of the rail-based vehicle, the vibrations being detectable using at least one wireless sensor, which is arranged in the region of the at least one wheel. The invention further relates generally to a method.

### BACKGROUND

Before the wheel is mounted on a rail-based vehicle, the wheel diameter can be measured with comparatively little effort, provided that the wheel diameter is not already known from the production of the wheel. The wheels of a rail vehicle, which roll on a rail, wear down during the operation of the vehicle, however. Mechanical wear occurs.

Therefore, the current wheel diameter must be regularly determined during the service life of the vehicle.

This can be carried out by manually measuring the wheel diameter again, for example, during maintenance of the vehicle. Measuring the wheel diameter again requires a great deal of effort, however. Furthermore, this also results in downtimes of the rail vehicle.

Alternatively, it is known to carry out calibration trips on selected reference routes having precisely measured reference points. This is also very complicated and costly, however.

DE 10 2015 225702 A1 discloses a method for determining a state of wear of wheels on a rail vehicle, including the steps: detecting a vehicle speed of the rail vehicle; detecting a rotational speed of a wheel of the rail vehicle for the detected vehicle speed; comparing the detected rotational speed of the wheel with the specified rotational speed of the wheel for the detected vehicle speed; and determining a characteristic value for the state of wear of the wheel depending on the result of the comparison of the detected rotational speed with the specified rotational speed.

### BRIEF SUMMARY

Example aspects of the invention provide an improved device and an improved method, with which a current wheel diameter of a wheel of a vehicle can be easily determined.

Example aspects of the invention provide a device for estimating a current wheel diameter of a wheel of a rail-based vehicle on a predetermined network of routes, the device having an interface for collecting vibration data as vibrations, of at least one wheel, acting on the rail-based vehicle, as an acceleration of the rail-based vehicle, the vibrations being detectable using at least one wireless sensor, which is arranged in the region of the at least one wheel, wherein a computing unit is provided for generating a predicted speed on the basis of the vibration data, and wherein a comparator unit is provided, which is designed to estimate a wheel diameter on the basis of the differences between the predicted speed and a detected corresponding ground truth speed.

Vibration data are to be understood as the collected raw time data from the sensor. This means that time is also recorded with the vibration data, and the vibration data are coupled to or associated with the time.

In a rail-based vehicle, a vibration in a vertical direction, for example, of a running wheel imbalance or a deviation of the perimeter of a running wheel from the shape of a circle, characterizes the current acceleration of the rail vehicle. These can be measured as vibration data.

In particular, the wireless sensor can be in the form of a radio sensor, which is arranged on the transmission or on the bogie of the rail-based vehicle, for example, a train.

The real ground speed, which is referred to here as the ground truth speed, can be detected, for example, as a GPS-based speed by the computing unit. The real ground speed is based on the same corresponding time period as the predicted speed. The ground truth speed can be determined via GPS positions. The ground truth speed, i.e., the real ground speed, can also be determined, for example, by passing through a geofence region while incorporating the covered rail segment and the time by determining the GPS positions (GPS data) of the rail-based vehicle. A geofence region is a virtual fence or perimeter around a physical location, in which, for example, particularly good/precise GPS detection is possible.

Further detection options are speed measurement or one wheel revolution per unit of time.

On the basis of the GPS positions, the covered distance, which is known from the network of routes, and the time, the GPS speed can be subsequently determined as a ground truth speed.

In example aspects of the invention, it was recognized that after the wheels have worn down (wear), the wheels must rotate faster in order to really or truly have the same speed as prior to the wear.

Consequently, the speed predicted on the basis of the vibration data is lower than the ground truth speed. A frequency shift, so to speak, occurs in the vibration data when the same ground truth speed is to be reached with wheels that are already worn.

For example, the curves which result from the frequencies of the vibration data can be used as a predicted speed, wherein a speed-dependent rotational speed parameter and the frequencies of the speed-dependent rotational speed parameter can be used here as a predicted speed.

This rotational speed parameter and the recorded frequencies of the rotational speed parameter can be determined from the vibration data by the comparator unit.

Therefore, an offset (deviation) is generated between the ground truth speed and the speed which has been predicted on the basis of the vibration data, via which the current wheel diameter and, on the basis thereof, the wear of the wheels, can be identified.

In particular, a sensor is arranged at each wheel and the vibration data for each wheel at a predicted speed are generated.

On the basis thereof, the wheel diameter and, on the basis thereof, the wear can be computed for each wheel.

The wheel diameter can therefore be estimated on the basis of the device according to example aspects of the invention via the change in the frequencies or via the differences between the real speed and the predicted speed.

In another example embodiment, the computing unit is designed to apply a time-resolved Fourier transform to the vibration data to generate a raw spectrogram. The computing unit is also designed to apply filtering to the raw spectrogram and, after filtering, to apply normalization to generate an acceleration spectrogram on the basis of the time-resolved, normalized vibration data in order to generate a predicted speed from the acceleration spectrogram.

A raw spectrogram is a spectrogram with the unprocessed vibration data as a frequency spectrum. An acceleration spectrogram can be understood to be the filtered and normalized raw spectrogram.

Consequently, the speed predicted on the basis of the acceleration spectrogram is lower than the ground truth speed. A frequency shift, so to speak, occurs in the acceleration spectrogram when the same ground truth speed is to be reached with wheels that are already worn. Therefore, an offset (deviation) is generated between the ground truth speed and the speed which has been predicted on the basis of the acceleration spectrogram, via which offset the current wheel diameter and, on the basis thereof, the wear of the wheels, can be identified.

The wheel diameter can therefore be estimated on the basis of the device according to example aspects of the invention via the change in the frequencies or via the differences between the real speed and the predicted speed.

In another example embodiment, the computing unit is designed to form a short-time Fourier transform (STFT) as an acoustic analysis of the raw spectrogram and/or the acceleration spectrogram. The STFT is represented, in particular, as pictorial diagram. In particular, this representation with a convolutional neural network is suitable as a machine learning method, such as a convolutional neural network, which is particularly well suited for a pictorial representation, such as the STFT.

In another example embodiment, the comparator unit is designed to determine a computational frequency shift due to a changed wheel diameter, the frequency shift computationally resulting when the predicted speed is adapted on the basis of the vibration data and the ground truth speed or on the basis of the acceleration spectrogram and the ground truth speed.

If the ground truth speed is then to be reached by the quasi-worn wheels, the wheels must rotate faster with smaller diameters, thereby resulting in a frequency shift in the acceleration spectrogram/the vibration data, which can be computationally determined. The wheel diameter can then be determined on the basis of this calculable frequency shift. This means that, so to speak, the curves which represent the frequencies of the speed-dependent rotational speed parameters are adapted (raised) to the curves of the ground truth speed in order to computationally obtain the same ground speed.

Therefore, the frequencies in the acceleration spectrogram/the vibration data can be compared with the GPS speed curve in order to be able to estimate the wheel diameter and, on the basis thereof, the wear, i.e., the new wheel diameter and the wear can be estimated on the basis of the “computational frequency shift.” The wheel diameter is therefore estimated via the change in the frequencies or via the differences between the real speed and the predicted speed.

In another example embodiment, the comparator unit is designed to estimate the frequency shift at least on the basis of a speed-dependent rotational speed parameter detected on the basis of the vibration data.

Such rotational speed parameters can be in the form of the toothing frequencies of the transmission of the rail vehicle and/or the wheel frequencies of the at least one wheel. These can be extracted from the acceleration spectrogram and are suitable for use in the online monitoring of the wheels of rail-based vehicles. A recorded frequency curve of a rotational speed parameter from the acceleration spectrogram is used as a predicted speed and compared with the ground truth speed.

In another example embodiment, the computing unit is designed to apply a median filter and/or a high-pass filter and/or a bandpass filter and/or a low-pass filter as filtering.

The median filtering smooths the arising wide-band interfering noises and interferences that are independent of the speed. These interferences that are independent of the speed arise, for example, due to superelevations and tilting of the train during changing rises and falls of the rail, which occur, for example, at the beginning of uphill or downhill travel.

Thereafter, the data are normalized.

In another example embodiment, the interface is designed to receive the GPS positions of the rail-based vehicle, wherein the device is designed to determine a ground truth speed on the basis of the GPS positions.

On the basis of the GPS positions, the covered distance, which is known from the network of routes, and the time, the GPS speed can be subsequently determined as a ground truth speed. As a result, the ground truth speed can be determined in a simple way.

In another example embodiment, a learning module is provided, which is designed to apply a trained machine learning method to the ground truth speed and the vibration data to determine the wheel diameter. The machine learning method is designed to estimate the wheel diameter on the basis of the ground truth speed and the vibration data or an acceleration spectrogram which has been generated on the basis of the vibration data.

The machine learning method can be a neural network. If the spectrogram is pictorial, in particular, a convolutional neural network can be used.

Training data must be generated in order to apply the machine learning method. These can be trained at a speed, for example, on the basis of a manual measurement of the wheel diameter and, if applicable, the wear of the wheel. The application by such a neural network has the advantage that the wheel diameter and the wear can also be estimated in unknown situations, for example, very high/very low wear, for which no comparable values yet exist, and therefore continuous monitoring is easily made possible. The neural network is trained to estimate the wheel diameter easily on the basis of the recorded vibration data (acceleration spectrogram) and the ground speed which has been estimated on the basis thereof, and the ground truth speed.

In another example embodiment, the machine learning method can also be designed to bring about an adaptation of the predicted speed on the basis of the vibration data and the ground truth speed or on the basis of the acceleration spectrogram and the ground truth speed, on the basis of which a frequency shift can be determined, and to determine the changed wheel diameter on the basis of the frequency shift. The predicted speed or its frequencies are computationally shifted, so to speak, such that the ground truth speed results. The wheel diameter can be determined from the offset between the real frequency and the frequency which is predicted by the neural network.

Furthermore, example embodiments of the present subject matter provide a method for estimating a current wheel diameter of a wheel of a rail-based vehicle on a predetermined network of routes, including:
collecting vibration data as vibrations, of at least one wheel, acting on the rail-based vehicle, as an acceleration of the rail-based vehicle, the vibrations being detectable using at least one wireless sensor, which is arranged in the region of the at least one wheel;
determining a predicted speed on the basis of the vibration data; and
estimating a wheel diameter on the basis of the difference between the predicted speed and an identified corresponding ground truth speed.

The method can be designed, in particular, to run on a device according to example aspects of the invention, in particular a cloud.

Furthermore, the advantages of the device can be transferred onto the method according to example aspects of the invention.

Moreover, the method further includes:
applying a time-resolved Fourier transform to the vibration data to generate a raw spectrogram;
applying a filtering to the raw spectrogram and applying a normalization after the filtering to generate an acceleration spectrogram on the basis of the time-resolved, normalized vibration data and determining a predicted speed on the basis of the acceleration spectrogram; and
estimating a wheel diameter on the basis of the difference between the predicted speed and an identified corresponding ground truth speed.

Furthermore, in another example embodiment, a computational frequency shift due to a changed wheel diameter is determined, the frequency shift computationally resulting when the predicted speed is adapted on the basis of the vibration data and the ground truth speed or on the basis of the acceleration spectrogram and the ground truth speed. If the ground truth speed is then to be determined by the quasi-worn wheels, the wheels must rotate faster with smaller diameters, on the basis of which a frequency shift in the acceleration spectrogram/the vibration data would arise, which can be computationally determined. The wheel diameter and, on the basis thereof, the wheel wear can then be determined on the basis of this calculable frequency shift.

Such a method can receive the vibration data and a time stamp, preferably from all wheels, by an onboard telematics gateway, which is simultaneously designed to receive, for example, the GPS positions of the rail-based vehicle when the rail-based vehicle travels above ground. On the basis of the GPS positions, the covered distance, which is known from the network of routes, and the time, the GPS speed can be subsequently determined as a ground truth speed.

Due to the wear, i.e., the smaller wheel diameter, the predicted speed is lower than the corresponding ground truth speed. A frequency shift, so to speak, occurs in the acceleration spectrogram/vibration data when the ground truth speed is to be reached with wheels that are already worn.

Therefore, an offset is generated between the ground truth speed and the predicted speed, via which the wheel diameter and, therefore, the wear of the wheels, can be identified.

In another example embodiment, the frequency shift is estimated at least on the basis of a rotational speed parameter which has been detected on the basis of the vibration data, wherein the toothing frequencies of a transmission and/or the wheel frequencies of the at least one wheel are used as rotational speed parameters.

In addition, a median filter and a low-pass filter and/or a bandpass filter and/or a high-pass filter can be applied. The vibration data can thus be optimally preprocessed.

In another example embodiment, the acceleration is collected as vibration data from all wheels by a wireless sensor, which is arranged in the region of the respective wheel. The wear can then be determined on the basis of the determination of the wheel diameter of each wheel.

In another example embodiment, GPS positions are used, on the basis of which a ground truth speed is determined.

In another example embodiment, a trained machine learning method is applied to the ground truth speed and the vibration data to determine the wheel diameter. The machine learning method is designed to estimate the wheel diameter on the basis of the ground truth speed and the vibration data or on the basis of the ground truth speed and an acceleration spectrogram which has been generated on the basis of the vibration data.

The machine learning method can be a neural network, in particular a convolutional neural network. Training data must be generated in order to apply the machine learning method. The neural network is trained to estimate the wheel diameter simply on the basis of the recorded vibration data (acceleration spectrogram) and the ground speed which has been estimated on the basis thereof, and the ground truth speed by utilizing manually measured wheel diameters, which are used for training. On the basis of these manually measured wheel diameters, the weightings of the individual neurons can be adapted with regard to detected faults after every pass.

The wear of the wheel results in a “computational frequency shift” since the wheel must rotate faster in order to reach the desired ground speed. On the basis of the convolutional neural network, the wear and the current wheel diameter of each individual wheel can then be determined by comparing the curves of the speed-dependent rotational speed parameters in the acceleration spectrogram/the vibration data with the ground truth speed.

### BRIEF DESCRIPTION OF THE DRAWINGS

Further example properties and advantages of the present invention are obvious from the following description with reference to the attached figures, wherein schematically:

FIG. 1 shows a rail-based vehicle with sensors;

FIG. 2 shows a device and the method schematically in a cloud;

FIG. 3 shows the received vibration data and their processing;

FIG. 4 shows a diagram with a speed-dependent rotational speed parameter;

FIG. 5 shows another diagram with a speed-dependent rotational speed parameter;

FIG. 6 shows another example embodiment of a device; and

FIG. 7 shows an acceleration spectrogram and a frequency shift.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

It is known that the wheels of a rail vehicle, which roll on a rail, wear down during operation of the vehicle. Mechanical wear occurs. Therefore, the current wheel diameter must be regularly determined during the service life of the vehicle. Measuring the wheel diameter again requires a great deal of effort, however, and results in downtimes of the rail vehicle.

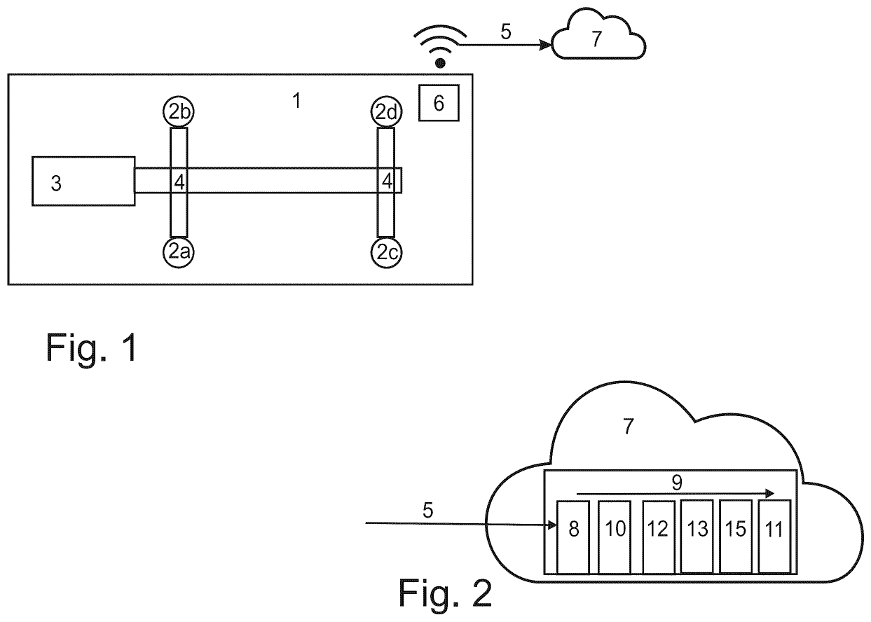

FIG. 1 shows a train 1 as a rail-based vehicle. The train 1 has a wireless sensor 2a, 2b, 2c, 2d at each wheel, in the vicinity of the wheel. The wireless sensors 2a, 2b, 2c, 2d can be arranged, for example, on the transmission 3 or the bogie 4 and transmit data by radio.

During the journey, the wireless sensors 2a, . . . , 2d record accelerations as vibration data 5, temperature data and tilt behavior as well as abnormalities in the wheel-rail contact.

The vibration data 5 of each wheel are transmitted to a telematics gateway 6 which is arranged on the train 1.

The telematics gateway 6 can transmit the vibration data 5, including a time stamp, to an external server, which is a cloud 7 in this case. Alternatively, the data can also be transmitted to a computer located in the train 1, for processing.

Furthermore, the telematics gateway 6 can detect the GPS positions of the train 1 when the train 1 travels above ground. Such a detection can take place in geofence regions with geofence points. A geofence region or geozone is a virtual fence around a physical region, in which, for example, the GPS positions can be precisely detected in this case.

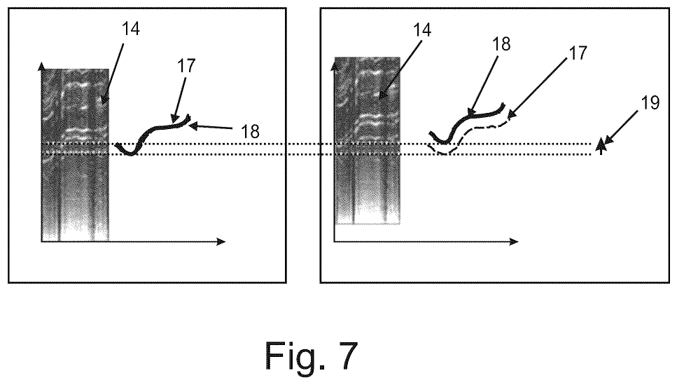

The GPS positions can also be transmitted with the corresponding vibration data 5 to the cloud 7. There, a GPS speed can be determined as a ground truth speed 17 (FIG. 7) on the basis of the GPS positions, the distance that was covered and the time required therefor.

FIG. 2 shows the device 9 and the method schematically in the cloud 7.

Alternatively, the device 9 and the method can also run in the train 1 itself, for example, on a server/computer located there.

The cloud 7 receives the vibration data 5 by the interface 8 and stores the vibration data 5 in a computing unit.

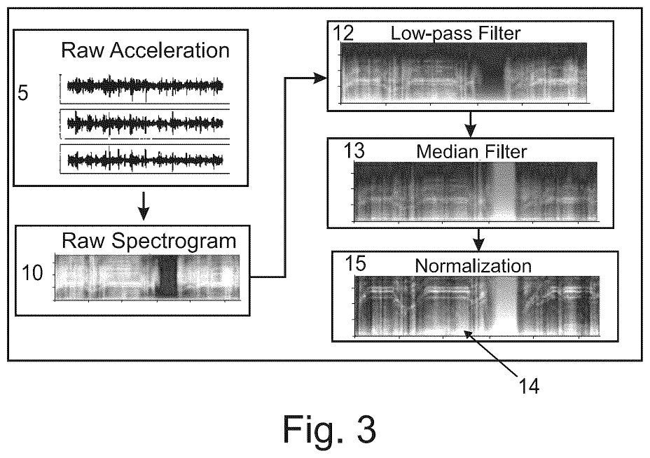

In the computing unit, a time-resolved Fourier transform is applied to the vibration data 5 to generate a raw spectrogram 10 (FIG. 3). The raw spectrogram 10 can be pictorially represented.

FIG. 3 shows the received vibration data 5 and the raw spectrogram 10. Initially, a low-pass filter 12 and, thereafter, a median filter 13 are applied to the raw spectrogram 10. Thereafter, normalization 15 is applied to the time-resolved, filtered vibration data 5 to generate an acceleration spectrogram 14. The filtering is carried out in order to eliminate the signal components in the measurement which are due to effects that are independent of the speed.

These effects can result due to superelevations and tilting of the train during changing rises and falls of the rail, which occur, for example, at the beginning of uphill or downhill travel.

On the basis of the acceleration spectrogram 14, a predicted speed can be determined by a comparator unit 11 on the basis of the vibration data.

If the wheels are not worn, the predicted speed and the ground truth speed 17 (FIG. 7) are nearly identical. After the wheels have become worn, however, the wheels must rotate faster in order to really have the same ground truth speed 17 (FIG. 7) as prior to the wear. An offset (deviation) arises between the ground truth speed 17 (FIG. 7) and the corresponding speed which has been predicted on the basis of the acceleration spectrogram 14.

For example, the curves which result from the frequencies of the vibration data can be used as a predicted speed, wherein, here, a speed-dependent rotational speed parameter and its frequency can be used as a predicted speed.

Therefore, a comparator unit 11 can determine the predicted speed on the basis of the acceleration spectrogram 14 and compare this with the determined ground truth speed 17 (FIG. 7).

To this end, the comparator unit 11 can extract a speed-dependent rotational speed parameter from the acceleration spectrogram 14, for example, the toothing frequencies of a transmission 3 and/or the wheel frequencies of the at least one wheel, and compare these with the ground truth speed 17 (FIG. 7), which has been determined on the basis of GPS positions.

On the basis of the computational frequency shift 19 (FIG. 7), which would computationally result during the adaptation of the predicted speed on the basis of the acceleration spectrogram 14 and the ground truth speed 17 (FIG. 7), the changed wheel diameter and thus the wear can be determined.

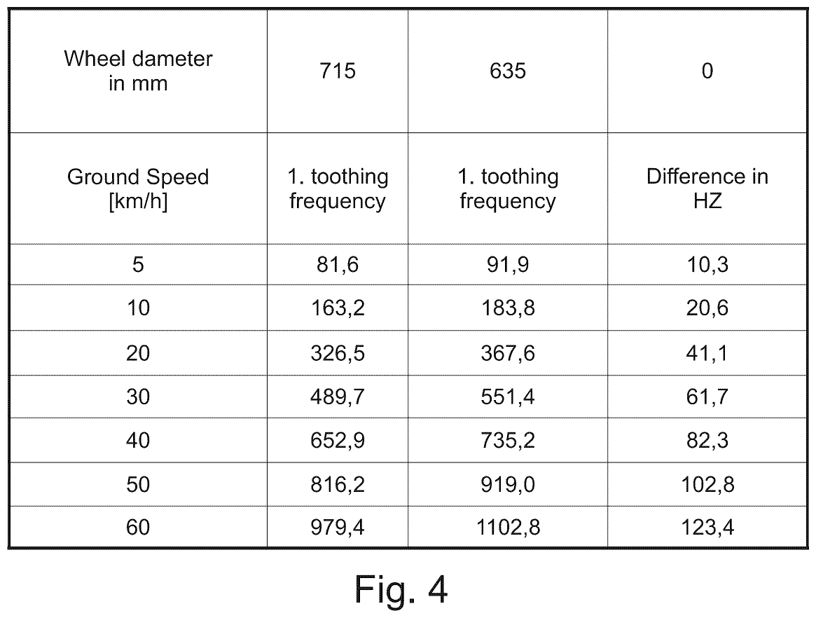

FIG. 4 shows a diagram with a speed-dependent rotational speed parameter, here the toothing frequencies of the transmission 3 recorded for a first wheel diameter, which is 715 mm in this case, and a second, smaller wheel diameter, which is six hundred and thirty-five millimeters (635 mm) in this case, at various ground speeds, and the frequency difference. A rotation operation of a wheel at higher train speeds shows differences of more than ten Hertz (10 Hz) with respect to the toothing frequencies.

The speed-dependent variables such as the toothing frequencies of the transmission 3 or the wheel frequencies of the wheel can be identified on the basis of the acceleration spectrogram 14. The wear of the wheel results in a “computational shift of the frequencies” since the wheel must rotate faster in order to reach the desired ground speed. The curves of the speed-dependent rotational speed parameters in the acceleration spectrogram 14 can be compared with the GPS speed as a ground truth speed 17 in order to calculate the wear. Thus, for example, the wear can be estimated on the basis of the frequency shift 19 (FIG. 7) in comparison to the ground truth speed 17.

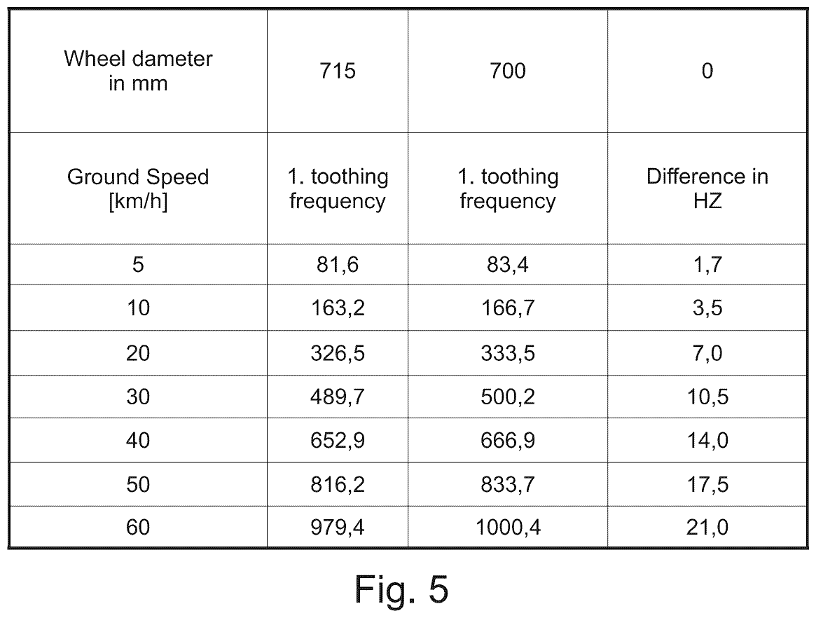

FIG. 5 shows another diagram with a speed-dependent rotational speed parameter, here the toothing frequencies of the transmission 3 recorded for a first wheel diameter, which is seven hundred and fifteen millimeters (715 mm) in this case, and a second, smaller wheel diameter, which is seven hundred millimeters (700 mm) in this case, at various ground speeds, and the frequency difference. The deviations can be measured by the device 9 according to example aspects of the invention even when there is only a slight amount of wear.

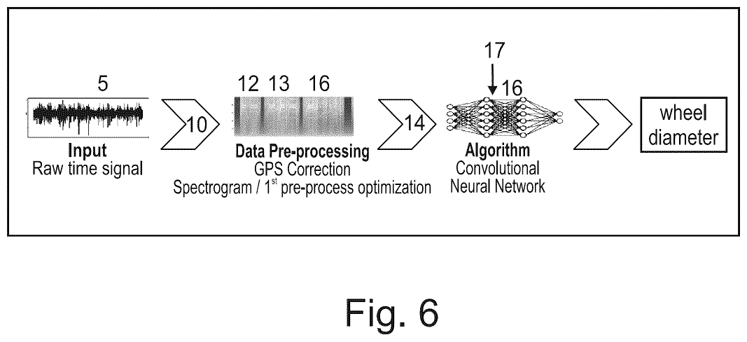

FIG. 6 shows another example embodiment of a device 9a. This device 9a has a learning module with a trained machine learning method. The machine learning method is, in particular, a convolutional neural network 16. This is trained to estimate, on the basis of the ground truth speed 17 and the acceleration spectrogram 14 and the predicted speed, which can be derived therefrom, a current wheel diameter and, on the basis thereof, determine the wear of the wheel. The convolutional neural network 16 is suitable, in particular, for a pictorial representation such as the acceleration spectrogram 14.

Training data must be generated in order to apply the convolutional neural network 16. The convolutional neural network 16 is trained to estimate the wheel diameter simply on the basis of the recorded vibration data (acceleration spectrogram 14) and the derivable, predicted ground speed which has been estimated on the basis thereof, and the ground truth speed 17 by utilizing manually measured wheel diameters, which are used for training. On the basis of these manually measured wheel diameters, the weightings of the individual neurons can be adapted with regard to detected faults after every pass.

Furthermore, the predicted speed can be adapted on the basis of the acceleration spectrogram 14 and the ground truth speed 17, and the changed wheel diameter can be determined by the convolutional neural network 16 on the basis of the computational frequency shift 19 (FIG. 7) which results.

FIG. 7 shows an acceleration spectrogram 14 with a curve 18 of an extracted, speed-dependent rotational speed parameter as a predicted speed.

If wheels are not worn, this curve 18 matches the measured ground truth speed 17 (image on the left).

If wheels are worn, this curve 18 of the predicted speed does not match the measured ground truth speed 17 (image on the right). A deviation arises between the ground truth speed 17 and the curve 18.

Due to the wear, a “computational frequency shift 19” arises in the acceleration spectrogram 14 in comparison to the ground truth speed 17, since, due to the wear, the wheels must rotate faster in order to reach the desired ground speed. The curve 18 of the speed-dependent rotational speed parameter, for example, the gearmesh frequency or the multiple of the wheel frequency in the acceleration spectrogram 14, is then adapted or adjusted to the ground truth speed 17 in order to computationally determine this frequency shift 19. The new wheel diameter and the wear can be estimated on the basis thereof.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE CHARACTERS

1 train
2a, 2b, 2c, 2d sensor
3 transmission
4 bogie
5 vibration data
6 telematics gateway
7 cloud
8 interface
9, 9a device
10 raw spectrogram
11 comparator unit
12 low-pass filter
13 median filter
14 acceleration spectrogram
15 normalization
16 convolutional neural network
17 ground truth speed
18 curve
19 frequency shift

1-17. (canceled)

18. A device (9, 9a) for estimating a current wheel diameter of a wheel of a rail-based vehicle on a predetermined network of routes, comprising:
an interface (8) for collecting vibration data (5) corresponding to vibrations of at least one wheel, the vibrations acting on the rail-based vehicle as an acceleration of the rail-based vehicle;
at least one wireless sensor (2a, 2b, 2c, 2d) arranged proximate the at least one wheel and configured for detecting the vibrations;
at least one computing unit configured for generating a predicted speed based on the vibration data (5) and for estimating a wheel diameter based on differences between the predicted speed and a detected corresponding ground truth speed (17).

19. The device (9, 9a) of claim 18, wherein the at least one computing unit is configured for:
applying a time-resolved Fourier transform to the vibration data (5) to generate a raw spectrogram (10);
applying a filter to the raw spectrogram (10); and
applying a normalization (15) to generate an acceleration spectrogram (14) based on the time-resolved, normalized vibration data (5) in order to generate the predicted speed from the acceleration spectrogram (14).

20. The device (9, 9a) of claim 19, wherein the at least one computing unit is configured to form a short-time Fourier transform (STFT) as an acoustic analysis of the raw spectrogram (10) and/or the acceleration spectrogram (14).

21. The device (9, 9a) of claim 18, wherein the at least one computing unit is configured for determining a computational frequency shift (19) due to a changed wheel diameter, the computational frequency shift (19) resulting when the predicted speed is adapted based on the vibration data (5) and the ground truth speed (17).

22. The device (9, 9a) of claim 21, wherein the at least one computing unit is configured for estimating the frequency shift (19) based on at least a speed-dependent rotational speed parameter detected based on the vibration data (5).

23. The device (9, 9a) of claim 22, wherein the at least one computing unit is configured for utilizing one or both of toothing frequencies of a transmission (3) and wheel frequencies of the at least one wheel as speed-dependent rotational speed parameters.

24. The device (9, 9a) of claim 18, wherein the at least one computing unit is configured for utilizing one or more of a high-pass filter, a low-pass filter, a bandpass filter, and a median filter (13) as filtering.

25. The device (9, 9a) of claim 18, wherein the interface (8) is configured for receiving GPS positions of the rail-based vehicle, and the device (9, 9a) is configured for determining the ground truth speed (17) based on the GPS positions.

26. The device (9, 9a) of claim 18, further comprising a learning module configured to apply a trained machine-learned model to the ground truth speed (17) and the vibration data (5) to determine the wheel diameter, wherein the trained machine-learned model is configured to estimate the wheel diameter based on the ground truth speed (17) and the vibration data (5).

27. The device (9, 9a) of claim 26, wherein:
the trained machine-learned model is configured to adapt the predicted speed based on the vibration data (5) and the ground truth speed (17), a frequency shift (19) determinable based on the adapted predicted speed; and
the trained machine-learned model is configured to determine the changed wheel diameter based on the frequency shift (19).

28. A method for estimating a current wheel diameter of a wheel of a rail-based vehicle on a predetermined network of routes, comprising:
collecting vibration data (5) of at least one wheel, corresponding to vibrations acting on the rail-based vehicle, as an acceleration of the rail-based vehicle using at least one wireless sensor (2a, 2b, 2c, 2d) arranged proximate the at least one wheel;
determining a predicted speed based on the vibration data (5); and
estimating a wheel diameter based on a difference between the predicted speed and an identified corresponding ground truth speed (17).

29. The method of claim 28, further comprising:
applying a time-resolved Fourier transform to the vibration data (5) to generate a raw spectrogram (10);
applying a filter to the raw spectrogram (10);
after the filter, applying a normalization (15) to generate an acceleration spectrogram (14) based on the time-resolved, normalized vibration data (5);
determining a predicted speed based on the acceleration spectrogram (14).

30. The method of claim 29, further comprising determining a computational frequency shift due to a changed wheel diameter, the computational frequency shift resulting when the predicted speed is adapted based on the vibration data (5) and the ground truth speed (17).

31. The method of claim 29, wherein the acceleration is detected as vibration data (5) from all wheels by the at least one wireless sensor (2a, 2b, 2c, 2d).

32. The method of claim 29, wherein using determined GPS positions of the rail-based vehicle to determine the ground truth speed (17).

33. The method of claim 29, further comprising applying a trained machine-learned model to the ground truth speed (17) and the vibration data (5) to determine the wheel diameter, wherein the trained machine-learned model is configured to estimate the wheel diameter based on the ground truth speed (17) and the vibration data (5).

34. The method of claim 33, further comprising:
adapting the predicted speed based on the vibration data (5) and the ground truth speed (17);
determining a frequency shift based on the adapted predicted speed; and
determining the changed wheel diameter using the trained machine-learned model based on the frequency shift.
